(19) United States
(12) Patent Application Publication
(10) Pub. No.: US 2010/0082361 A1
(43) Pub. Date: Apr. 1, 2010

(54) Apparatus, System and Method for Predicting Attitudinal Segments

(75) Inventors: Taylor Dennen, Blue Bell, PA (US); Jean W. Rawlings, Roy, UT (US)

Correspondence Address: FULBRIGHT & JAWORSKI L.L.P., 600 CONGRESS AVE., SUITE 2400, AUSTIN, TX, 78701, US

(73) Assignee: INGENIX, INC., Eden Prairie, MN (US)

(21) Appl. No.: 12/569,709

(22) Filed: Sep. 29, 2009

Related U.S. Application Data
(60) Provisional application No. 61/101,098, filed on Sep. 29, 2008.

(51) Int. Cl. G06Q 99/00

(52) U.S. Cl. 705/1

(57) ABSTRACT

An apparatus, system, and method are presented for predicting attitudinal segments. In one embodiment, the method includes receiving a set of data elements associated with an individual, calculating a score for one or more attitudinal dimensions to associate with the individual in response to the set of data elements, calculating an attitudinal segment to associate with the individual in response to the score for the one or more attitudinal dimensions, and generating an output configured to associate the attitudinal segment with the individual.

### CROSS REFERENCE TO RELATED APPLICATIONS

This application claims the benefit of U.S. Provisional Application No. 61/101,098 filed Sep. 29, 2008, the entire contents of which are incorporated herein by reference without disclaimer.

### BACKGROUND OF THE INVENTION

1. Field of the Invention

The present invention relates generally to data analysis, and more particularly to an apparatus, system, and method for predicting attitudinal segments.

2. Description of Related Art

Allocation of financial resources to marketing and advertising of products and services or development of community, health, or social programs can be challenging. Often the cost of spreading the word about a new product, service or program may cost more that the development of the product, service or program. Unfortunately, a large portion of those marketing and advertising funds are wasted on recipients who either don't care about the advertisement, or are unable to take advantage of the advertisement for financial or other reasons.

In order to tailor a marketing plan to a targeted group of individuals, certain companies may conduct a survey of potential customers to identify a group that are likely to respond to the advertisement, product, service, or program. Depending upon the complexity of the survey and the volume of participants, such companies may make significant financial investments in conducting the survey. Typical surveys are conducted either by direct telephone contact or through interactive web forms. For example, a typical company may send a mass email to a list of customers asking them to participate in a web based survey. Typically, companies will offer some financial incentive or reward for participation in the survey. These rewards add to the cost of conducting the survey.

Since surveys are extremely expensive, and may cost more than mass marketing, companies may only target a certain portion of their customers to determine an optimal advertising scheme or early in a project's life cycle to determine whether to further pursue the project. Unfortunately, these types of surveys typically do not identify a broad subset of customers who are most likely to respond to the advertisement or program.

The referenced shortcomings are not intended to be exhaustive, but rather are among many that tend to impair the effectiveness of previously known techniques for customer surveying; however, those mentioned here are sufficient to demonstrate that the methodologies appearing in the art have not been satisfactory and that a significant need exists for the techniques described and claimed in this disclosure.

### SUMMARY OF THE INVENTION

An apparatus, system, and method are presented for predicting attitudinal segments. In one embodiment, the method includes receiving a set of data elements associated with an individual, calculating a score for one or more attitudinal dimensions to associate with the individual in response to the set of data elements, calculating an attitudinal segment to associate with the individual in response to the score for the one or more attitudinal dimensions, and generating an output configured to associate the attitudinal segment with the individual.

In a further embodiment, calculating the one or more attitudinal dimensions may include calculating a result of a correlation function associated with a data element in the set of data elements, wherein the correlation function represents a correlation between a value of the data element and the one or more attitudinal dimensions associated with the data element. The correlation function may be determined in response to an output of a statistical modeling tool. The modeling tool may additionally calculate a weighting coefficient associated with the correlation function. In a further embodiment, calculating the weighting coefficient also includes optimizing the weighting coefficient associated with the correlation function in response to a logistic regression optimization. The weighting coefficient may be stored in a table of one or more weighting coefficients.

In one embodiment, the score for the one or more attitudinal dimensions may include a binary value. The attitudinal dimensions may include a health score, a wealth score, and an engagement score. The attitudinal segment may be selected from the group of attitudinal segments consisting of Ailing and Dismayed, Help Seeker, Blasé, System Expert, Young Minded, Value Seeker, Status Quo, and Fit & Happy, wherein the attitudinal segment corresponds to a personal attitude characteristic of the individual as expressed in the set of data elements.

A computer readable medium comprising machine-readable instructions for predicting an attitudinal segment is also presented. In one embodiment, the computer readable medium encodes instructions for receiving a set of data elements associated with an individual, calculating one or more attitudinal dimensions to associate with the individual in response to the set of data elements, calculating an attitudinal segment to associate with the individual in response to the one or more attitudinal dimensions, and associating the attitudinal segment with the individual.

An apparatus for predicting an attitudinal segment is also presented. In one embodiment the apparatus includes a receiver module configured to receive a set of data elements associated with an individual. The apparatus may also include a dimension calculator coupled to the receiver module, the dimension processor configured to calculate one or more attitudinal dimensions to associate with the individual in response to the set of data elements. Additionally, the apparatus may include a segment calculator coupled to the dimension calculator, the segment calculator configured to calculate an attitudinal segment to associate with the individual in response to the one or more attitudinal dimensions. The apparatus may also include an association module coupled to the segment calculator, the association module configured to associate the attitudinal segment with the individual. The apparatus may include additional modules configured to carry out the various additional embodiments of the method described above.

A system for predicting an attitudinal segment is also presented. In one embodiment, the system includes a data storage device configured to store a set of data elements associated with an individual. The system may also include a server coupled to the data storage device. The server may be configured to receive a set of data elements associated with an individual, calculate one or more attitudinal dimensions to associate with the individual in response to the set of data elements, calculate an attitudinal segment to associate with the individual in response to the one or more attitudinal dimensions, and associate the attitudinal segment with the individual. The system may include additional components configured to carry out the various embodiments of the method described above.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram illustrating one embodiment of a system for predicting attitudinal segments.

FIG. 2 is a schematic block diagram illustrating one embodiment of a computing device configured to read machine-readable instructions from a computer readable medium.

FIG. 3 is a schematic block diagram illustrating one embodiment of an apparatus for predicting attitudinal segments.

FIG. 4 is a schematic flowchart diagram illustrating one embodiment of a method for predicting attitudinal segments.

FIG. 5 is a schematic flowchart diagram illustrating one embodiment of a method for developing a model for predicting attitudinal segments.

### DESCRIPTION OF ILLUSTRATIVE EMBODIMENTS

The invention and the various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

The presented embodiments may assist insurance companies, marketing professionals, universities and other organizations interested in consumer habits, attitudes, and behaviors to better understand, predict and influence consumer behaviors, so that they can reach the right populations at the right time with the right types of advertising, education or training programs, or other interventions. In an embodiment relating to healthcare, the various components described herein may integrate prevention, risk reduction, disease management data, consumer data, demographic data, claims data, and personal information about individual consumers to optimize and target outreach programs based on predicted response levels. This approach may lead to better health outcomes and enhanced sustainable results of healthcare programs.

In alternative embodiments, the described methods may be utilized with conjunction with various data sets associated with consumers from various data sources to optimize marketing and advertising campaigns, research impact of governmental or social programs, and the like. For example, Federal or State governments may use tax data, social security data, census data, demographic data, and the like to research and predict needs for and responsiveness to certain social programs. For example, education programs such as adult reading programs, English as a Second Language (ESL) programs, drug awareness programs, and the like may not only be targeted based on need, but also based on a prediction of responsiveness using the methods and systems of the present embodiments. In an alternative embodiment, telephone companies may use telephone usage data along with various other data sources to determine an optimum incentive package for consumers.

In certain embodiments described herein, the present embodiments may be configured to generate and analyze correlations between certain predictive data and predicted results that may not traditionally be considered. For example, the present embodiments may use activity in particular hobbies as a predictor of an attitude toward healthcare programs or marketing. Thus, the present embodiments may make use of a wide range of data to generate predictions about and solutions for highly impactful advertising campaigns and social or health programs.

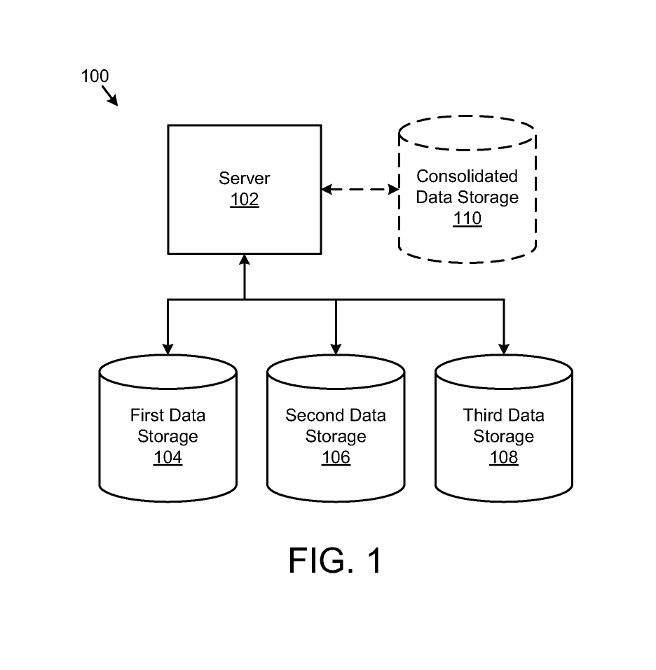

FIG. 1 illustrates one embodiment of a system 100 for predicting attitudinal segments. In the depicted embodiment, the system may include a server 102. In one embodiment, the system 100 may include a first data storage device 104, a second data storage device 106 and a third data storage device 108. In further embodiments, the system 100 may include additional data storage devices (not shown). In such an embodiment, each data storage device may host a separate database of customer information. The customer information in each database may be keyed to a common identifier such as an individual's name, social security number, customer number, or the like.

In one embodiment, the server 102 may submit a query to each of the data storage devices 104-106 to collect a consolidated set of data elements associated with an individual or group of individuals. In one embodiment, the server 102 may store the consolidated data set in a consolidated data storage device 110. In such an embodiment, the server 102 may refer back to the consolidated data storage device 110 to obtain a set of data elements associated with a specified individual. Alternatively, the server 102 may query each of the data storage devices 104-108 independently or in a distributed query to obtain the set of data elements associated with a specified individual. In another alternative embodiment, multiple databases may be stored on a single consolidated data storage device 110.

In various embodiments, the server 102 may communicate with the data storage devices 104-110 over a data bus, a Storage Area Network (SAN), a Local Area Network (LAN), or the like. The communication infrastructure may include Ethernet, Fibre-Chanel Arbitrated Loop (FC-AL), Small Computer System Interface (SCSI), and/or other similar data communication schemes associated with data communication. For example, there server 102 may communicate indirectly with the data storage devices 104-110; the server first communicating with a storage server or storage controller (not shown).

In one example of the system 100, the first data storage device 104 may store data associated with insurance claims made by an individual. The insurance claims data may include data associated with medical services, procedures, and prescriptions utilized by the individual. In this example, the second data storage device 106 may store summary data associated with the individual. The summary data may include one or more diagnoses of conditions from which the individual suffers and/or actuarial data associated with an estimated cost in medical services that the individual is likely to incur. The third data storage device 108 may store customer service and program service usage data associated with the individual. For example, the third data storage device 108 may include data associated with the individual's interaction or transactions on a website, calls to a customer service line, or utilization of a preventative medicine health program. A fourth data storage device (not shown) may store marketing data. For example, the marketing data may include information relating to the individual's income, race or ethnicity, credit ratings, etc. In one embodiment, the marketing database may include marketing information available from a commercial direct marketing data provider.

The server 102 may host a software application configured for prediction of an attitudinal segment to associate with the individual. The software application may further include modules or functions for interfacing with the data storage devices 104-110, interfacing a network (not shown), interfacing with a user, and the like. In a further embodiment, the server 102 may host an engine, application plug-in, or application programming interface (API). In another embodiment, the server 102 may host a web service or web accessible software application.

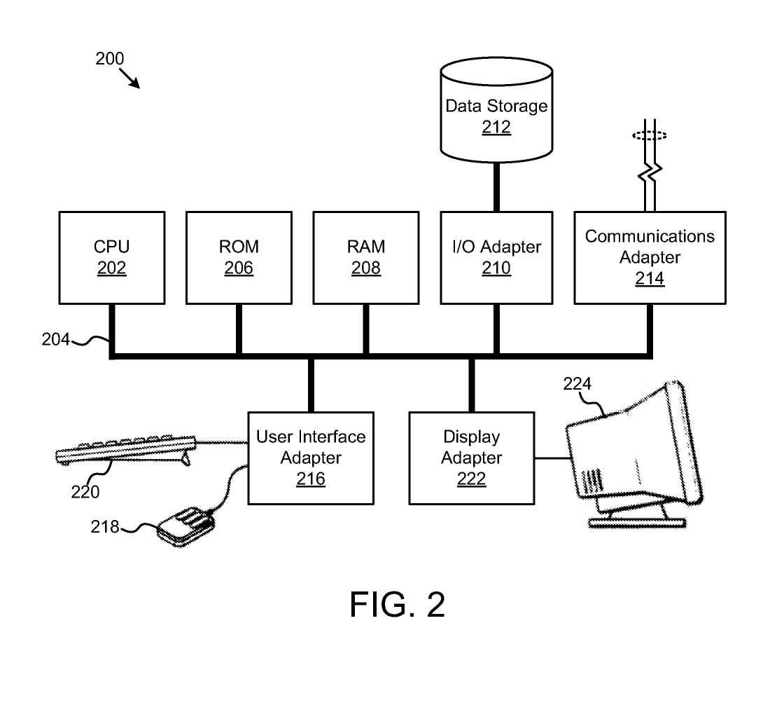

FIG. 2 illustrates a computer system 200 adapted according to certain embodiments of the server 102 and/or a user interface device (not shown). The central processing unit (CPU) 202 is coupled to system bus 204. The CPU 202 may be any general purpose CPU. The present embodiments are not restricted by the architecture of the CPU 202 as long as the CPU 202 supports the modules and operations as described herein. The CPU 202 may execute the various logical instructions according to the present embodiments. For example, the CPU 202 may execute machine-level instructions according to the exemplary operational flows described above in conjunction with below.

The computer system 200 also may include Random Access Memory (RAM) 208, which may be SRAM, DRAM, SDRAM, or the like. The computer system 200 may utilize RAM 208 to store the various data structures used by a software application configured to perform best match search. The computer system 200 may also include Read Only Memory (ROM) 206 which may be PROM, EPROM, EEPROM, or the like. The ROM may store configuration information for booting the computer system 200. The RAM 208 and the ROM 206 hold user and system 100 data.

The computer system 200 may also include an input/output (I/O) adapter 210, a communications adapter 214, a user interface adapter 216, and a display adapter 222. The I/O adapter 210 and/or user the interface adapter 216 may, in certain embodiments, enable a user to interact with the computer system 200 in order to initiate the process of predicting an attitudinal segment for a selected group of individuals. In a further embodiment, the display adapter 222 may display a graphical user interface associated with a software or web-based application for predicting an attitudinal segment.

The I/O adapter 210 may connect to one or more storage devices 212, such as one or more of a hard drive, a Compact Disk (CD) drive, a floppy disk drive, a tape drive, to the computer system 200. In one embodiment, the storage devices 212 comprise a computer readable medium. The communications adapter 214 may be adapted to couple the computer system 200 to the network 106, which may be one or more of a LAN and/or WAN, and/or the Internet. The user interface adapter 216 couples user input devices, such as a keyboard 220 and a pointing device 218, to the computer system 200. The display adapter 222 may be driven by the CPU 202 to control the display on the display device 224.

The present embodiments are not limited to the architecture of system 200. Rather the computer system 200 is offered as an example of one type of computing device that may be adapted to perform the functions of either the server 102. For example, any suitable processor-based device may be utilized including without limitation personal data assistants (PDAs), computer game consoles, and multi-processor servers. Moreover, embodiments of the present invention may be implemented on application specific integrated circuits (ASIC) or very large scale integrated (VLSI) circuits. In fact, persons of ordinary skill in the art may utilize any number of suitable structures capable of executing logical operations according to the embodiments of the described embodiments.

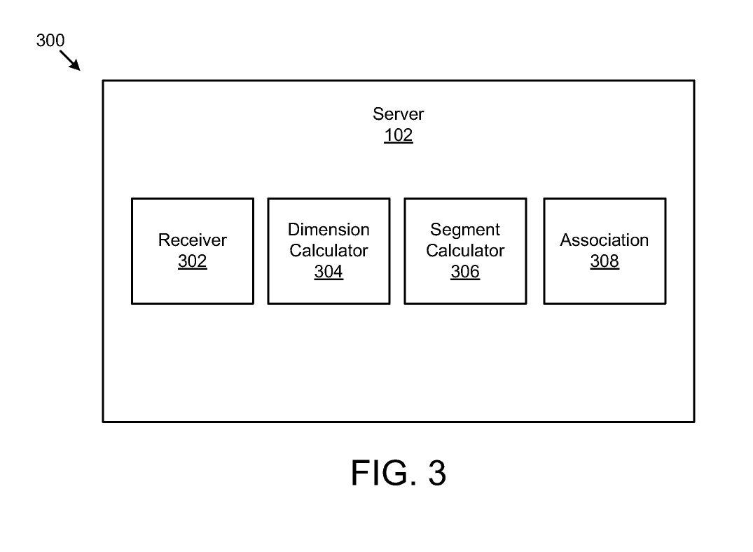

FIG. 3 illustrates one embodiment of an apparatus 300 for predicting an attitudinal segment for an individual. In the depicted embodiment, the apparatus 300 may include the server 102. The server 102 may include a receiver module 302 a dimension calculator module 304, a segment calculator module 306, and an association module 308.

In one embodiment, the receiver module 302 may include communications adapter 214, an I/O adapter 210, a user interface adapter 216, or the like. Alternatively, the receiver module 302 may include a software defined input port configured to receive the data elements as parameters of a function call, application call, or the like. The receiver module may receive a set of data elements associated with an individual.

For example, a software application hosted by the server 102 may retrieve the set of data elements from the consolidated data storage device 110 using an SQL query. The software application may then store the set of data elements in a memory device 208. The software application may call a function associated with the modules 302-308 of the apparatus 300. The function call may include parameters associated with the set of data elements. For example, the function call may include a series of pointers associated with the position within the RAM 208 in which the set of data elements are stored. In such an embodiment, the modules of the apparatus 300 may be defined within the CPU 202 as a configuration of transistors, registers, and other components of the CPU 202, wherein the configuration is determined by the software code.

In one embodiment, the dimension calculator 304 may calculate a score for one or more attitudinal dimensions to associate with the individual in response to the set of data elements. The dimension calculator 304 may include a set of one or more correlation elements configured to determine a correlation between a value of a data element selected from the set of data elements and an attitudinal dimension. For example, a data element may include an age value associated with an individual. The dimension calculator may compute a correlation score or value based on a predetermined correlation between age and a specified attitudinal dimension. In this example, the age of the individual may be computed in a predetermined equation configured to determine a correlation between age and the attitudinal dimensions of wealth, health, or engagement.

In the examples described above, it has been determined that an individual's attitudinal dimensions of wealth, health, and engagement in life may be used to calculate an attitudinal segment representing the individual's general attitude toward life, or alternatively individual's specific attitude or responsiveness to a particular product, service, advertisement, or program. The correlation may be determined in response to results of a survey as described in FIG. 6 below. Specifically, the dimension calculator 304 may include a series of relationships between certain identified data elements and the attitudinal dimensions. The relationships may be coded in the form of software statements or equations. Alternatively, the relationships may be coded in digital or analog logic.

A predetermined set of specific relationships between a selected group of data elements and the attitudinal segments may represent a predictive model. The predictive model may include one or more equations representing the correlation or relationship between one or more data elements and the one or more attitudinal dimensions. The equations or relationships may include one or more weighting coefficients which may be stored in a table. The table may be stored in RAM 208. Alternatively, the weighting coefficients may be hard coded in software, firmware, digital logic, or analog logic. In various embodiments, the table may include a multidimensional array, a hash table, an array of pointers to locations in RAM 208 where the weighting coefficients are stored, or the like.

In one embodiment, the correlations or relationships may be determined by a numerical analysis tool. For example, Statistical Analysis Software (SAS®) is one type of numerical analysis tool that may be used to determine the correlation functions. The weighting coefficients may be further optimized or refined by a second numerical analysis tool. The second optimization tool may be configured to perform a logistic regression on the predictive model to determine optimum weighting coefficients. Further embodiments of methods for determining the predictive model are described below with reference to FIG. 6.

In one embodiment, the dimension calculator 304 may calculate a score for each attitudinal dimension in response to the values of the data elements. The score may comprise a binary value of either ‘1’ or ‘0.’ Although in certain embodiments, the results of the various calculations in the predictive model may yield probability values of greater than zero, but less than one, a binary score may be calculated using a Logit function and assigning a threshold value to determine a value to round up to ‘1’ or a value to round down to ‘0.’ One example of an equation that may be used to determine a correlation between data elements and an attitudinal dimension may include:

Logit(D_{i,n})=βₒ+βₗGⱼₙ+β₂Eₖₙ+β₃Kₘₙ+εₙ

In this equation, D is the dimension (e.g., Health, Wealth, Engagement), G represents data elements from a first data set, E represents data elements from a second data set, and K represents data elements from a third data set. Certain other attitudinal dimensions may be considered. Additionally, this equation includes an error term ε for correcting errors and multiple weighting coefficients β. The Logit operator may produce a binary result and can be defined as:

$$Logit ( P ) = log ( \frac{P}{1 - P} )$$

In this described equation, the log function may include a natural logarithm (ln) having a base of Euler's number ‘e.’ P may include a correlation probability (P(X|Y)) relating to a correlation between the data element and a likelihood of the individual having a particular score associated with the attitudinal dimension. For example, the Logit function may determine a score between 1 and 0 correlating to a probability that the individual does or does not possess characteristics associated with one of the attitudinal dimensions based on the data element values. It may be necessary to assign a threshold value for rounding up to ‘1’ or down to ‘0.’ In one embodiment, if the output of the Logit function is greater than or equal to 0.5, the dimension calculator 304 assigns a score of ‘1,’ and if the value is less than 0.5, the dimension calculator 304 assigns a score of ‘0.’ The threshold value may be adjusted, or the error correction value may be adjusted to compensate for an identifiably high false positive or false negative rate for an attitudinal dimension.

In one embodiment, an attitudinal dimension may include a label. The label may include wealth, health, engagement, or other similar labels associated with how data associated with that attitudinal dimension correlates to an attitudinal segment. For example, in a consumer environment certain other attitudinal dimensions such as willingness to spend money, indebtedness, or the like may be of interest and calculated by the dimension calculator 304. The dimension calculator 304 may calculate a score of either ‘1’ or ‘0’ associated with the attitudinal dimensions.

In one embodiment, the dimension calculator 304 may assign a score for each of a wealth, a health, and an engagement attitudinal dimension associated with an individual. In this example, there may be two raised to the third power (2³), or eight (8) separate results. The segment calculator 306 may calculate or determine an attitudinal segment to associate with the individual in response to the score for the one or more attitudinal dimensions. For example, the segment calculator 306 may calculate the attitudinal segment associated with healthcare based on the scores of the one or more attitudinal dimensions according to the relationships described in table 1 below.

TABLE 1
calculation of attitudinal segment in response to attitudinal
dimension scores in a healthcare related application.

| Segment Label | Health | Wealth | Engaged |
|---|---|---|---|
| Nowhere to Turn/Ailing and Dismayed | 0 | 0 | 0 |
| Help Seeker | 0 | 0 | 1 |
| Blasé | 0 | 1 | 0 |
| System Expert | 0 | 1 | 1 |
| Young Minded | 1 | 0 | 0 |
| Value Seeker | 1 | 0 | 1 |
| Status Quo | 1 | 1 | 0 |
| Fit & Happy | 1 | 1 | 1 |

In an alternative embodiment, the segment calculator 306 may calculate the attitudinal segment according to one or more predetermined functions correlating the scores for the one or more attitudinal dimensions with the attitudinal segment. Such a function may also include one or more weighting factors or coefficients. Other attitudinal segments may be identified for other commercial sectors such as consumer debt reduction, marketing, and the like. The specific name of the attitudinal segment may be determined based on the most predictive characteristics of responsiveness to adds and programs as determined through prior research, surveys, and data analysis.

In one embodiment, the association module 308 may associate the attitudinal segment calculated by the segment calculator 306 with the individual. For example, if the segment calculator 306 determines that the individual is associated with the “Fit & Happy” segment based on the attitudinal dimension scores calculated by the dimension calculator 304, the association module 308 may generate an output comprising an identifier associate with the individual and the segment label “Fit & Happy” or a corresponding value or identifier. Alternatively, the association module 308 may generate a table of individuals and their associated attitudinal segments. In another alternative embodiment, the association module may display a message indicating the individual's attitudinal segment, or the like.

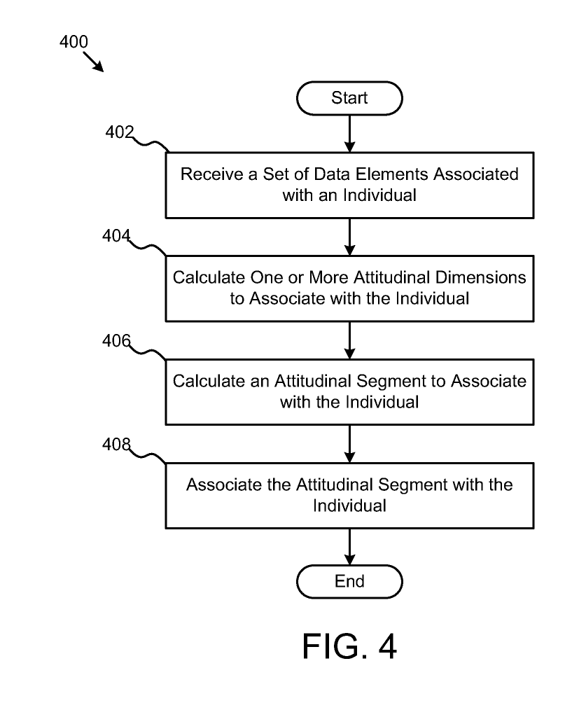

FIG. 4 illustrates one embodiment of a method 400 for predicting attitudinal segments. In one embodiment, the method 400 starts when the receiver module 302 receives 402 a set of data elements associated with an individual. The dimension calculator 304 may then calculate 404 one or more attitudinal dimensions to associate with the individual. For example, a score associated with a health dimension, a wealth dimension, and an engagement dimension may be calculated. The segment calculator 306 may then calculate 406 an attitudinal segment to associate with the individual. The segment calculator 306 may calculate 406 the attitudinal segment in response to the scores associated with the one or more attitudinal dimensions calculated 404 by the dimension calculator 304. For example, the segment calculator 306 may assign the individual to a labeled attitudinal segment including Ailing and Dismayed, Help Seeker, Blasé, System Expert, Young Minded, Value Seeker, Status Quo, or Fit & Happy. The labeled attitudinal segment may correspond to a personal attitude characteristic of the individual as expressed in the set of data elements. The association module 308 may then associate 408 the attitudinal segment calculated by the segment calculator 306 with the individual, and the method 400 may end.

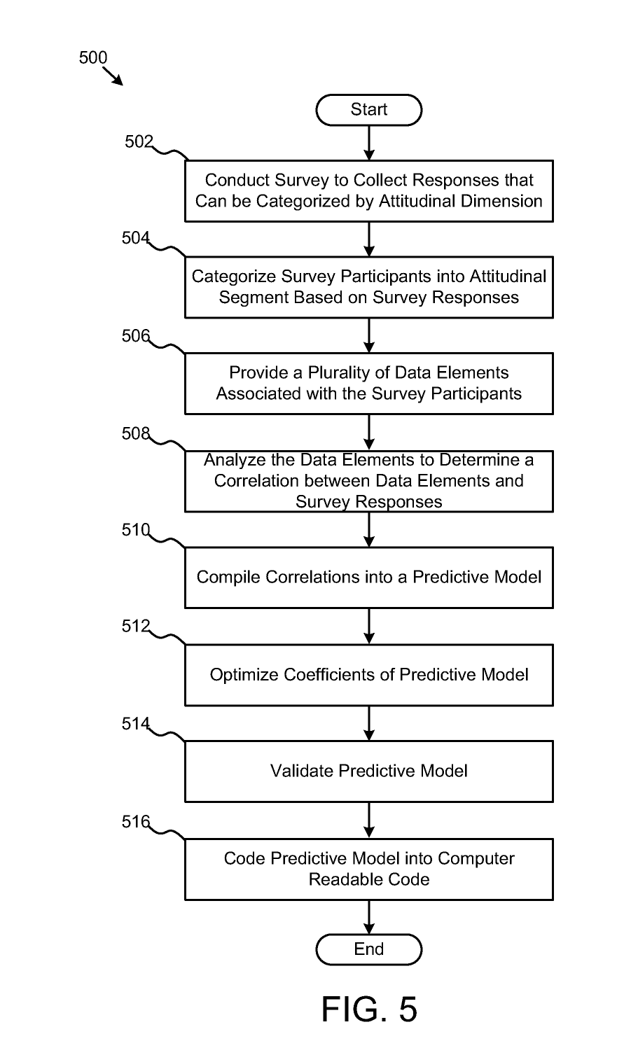

FIG. 5 illustrates one embodiment of a method 500 for developing a model for predicting attitudinal segments. In one embodiment, the method 500 includes conducting 502 a survey to collect responses that can be categorized into one or more of the attitudinal dimensions. The method 500 may also include categorizing 504 the survey participants into attitudinal segments in response to the survey responses. In one embodiment, a plurality of data elements associated with the survey participants may be provided 506. For example, the data elements may be entered into a statistical modeling tool or numerical analysis tool.

The method may further include analyzing 508 the data elements to determine a correlation between the data elements and the survey responses, as well as a correlation function for modeling a correlation between the data element and the response or the attitudinal dimension or both. For example, a statistical analysis tool may identify certain data elements that are predictive of certain responses. The details of the operation of the numerical analysis tools are omitted so that the present embodiments are not unnecessarily obscured by information known to one skilled in the art of numerical analysis. However, one embodiment of a numerical or statistical analysis tool may include statistical software such as SAS®. In one embodiment, the statistical analysis software may perform a canonical correlation to determine the correlations. Alternatively, the statistical analysis software may perform a factorial analysis to determine the correlations.

In a further embodiment, the method 500 may include compiling 510 the correlations into a statistical model. For example a predictive model may include one or more functions configured to calculate a correlation between one or more of the data elements and an attitudinal dimension. The predictive model may be entered into a statistical or numerical analysis tool, such as SAS® to optimize 512 one or more weighting coefficients associated with the predictive model. For example a logistic regression may be performed on the predictive model to optimize 512 the weighting coefficients.

Once the predictive model has been compiled 510 and optimized 512, it may be validated 514 to ensure that data elements selected and the correlation functions calculated correctly predict the likelihood that the individual will fall within a predicted attitudinal segment. In one embodiment, the predictive model may be created based on responses from a first group of survey participants, and the predictive model may be validated 514 using responses from a second group of survey participants, where both the first group and the second group of survey participants responded to the same set of survey questions.

Once the predictive model has been compiled 510, optimized 512, and validated 514, it may be coded 516 into computer readable code. Alternatively, the predictive model may be encoded in digital logic, analog logic, firmware, or the like. In these various embodiments, the predictive model provide the logical basis for the modules 302-308 of the apparatus 300.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

1. A method comprising:
receiving a set of data elements associated with an individual;
calculating a score for one or more attitudinal dimensions to associate with the individual in response to the set of data elements;
calculating an attitudinal segment to associate with the individual in response to the score for the one or more attitudinal dimensions; and
generating an output configured to associate the attitudinal segment with the individual.

2. The method of claim 1, wherein calculating the one or more attitudinal dimensions further comprises calculating a result of a correlation function associated with a data element in the set of data elements, wherein the correlation function represents a correlation between a value of the data element and the one or more attitudinal dimensions associated with the data element.

3. The method of claim 2, wherein the correlation function is determined in response to an output of a statistical modeling tool.

4. The method of claim 2, further comprising calculating a weighting coefficient associated with the correlation function.

5. The method of claim 4, wherein calculating the weighting coefficient further comprises optimizing the weighting coefficient associated with the correlation function in response to a logistic regression optimization.

6. The method of claim 4, further comprising storing the weighting coefficient in a table of one or more weighting coefficients.

7. The method of claim 1, wherein the score for the one or more attitudinal dimensions comprises a binary value.

8. The method of claim 1, wherein attitudinal dimensions further comprise a health score, a wealth score, and an engagement score.

9. The method of claim 1, wherein the attitudinal segment is selected from the group of attitudinal segments consisting of Ailing and Dismayed, Help Seeker, Blasé, System Expert, Young Minded, Value Seeker, Status Quo, and Fit & Happy, wherein the attitudinal segment corresponds to a personal attitude characteristic of the individual as expressed in the set of data elements.

10. A tangible computer readable medium comprising machine-readable instructions for:
receiving a set of data elements associated with an individual;
calculating one or more attitudinal dimensions to associate with the individual in response to the set of data elements;
calculating an attitudinal segment to associate with the individual in response to the one or more attitudinal dimensions; and
associating the attitudinal segment with the individual.

11. An apparatus comprising:
a receiver module configured to receive a set of data elements associated with an individual;
a dimension calculator coupled to the receiver module, the dimension processor configured to calculate one or more attitudinal dimensions to associate with the individual in response to the set of data elements;
a segment calculator coupled to the dimension calculator, the segment calculator configured to calculate an attitudinal segment to associate with the individual in response to the one or more attitudinal dimensions; and
an association module coupled to the segment calculator, the association module configured to associate the attitudinal segment with the individual.

12. A system comprising:
a data storage device configured to store a set of data elements associated with an individual; and
a server coupled to the data storage device, the server configured to:
receive a set of data elements associated with an individual;
calculate one or more attitudinal dimensions to associate with the individual in response to the set of data elements;
calculate an attitudinal segment to associate with the individual in response to the one or more attitudinal dimensions; and
associate the attitudinal segment with the individual.

13. The system of claim 12, wherein the server is configured to calculate a result of a correlation function associated with a data element in the set of data elements, wherein the correlation function represents a correlation between a value of the data element and the one or more attitudinal dimensions associated with the data element.

14. The system of claim 13, wherein the correlation function is determined in response to an output of a statistical modeling tool.

15. The system of claim 13, wherein the server is configured to calculate a weighting coefficient associated with the correlation function.

16. The system of claim 15, wherein calculating the weighting coefficient further comprises optimizing the weighting coefficient associated with the correlation function in response to a logistic regression optimization.

17. The system of claim 15, comprising a data storage device configured to store the weighting coefficient in a table of one or more weighting coefficients.

18. The system of claim 12, wherein the score for the one or more attitudinal dimensions comprises a binary value.

19. The system of claim 12, wherein attitudinal dimensions further comprise a health score, a wealth score, and an engagement score.

20. The system of claim 12, wherein the attitudinal segment is selected from the group of attitudinal segments consisting of Ailing and Dismayed, Help Seeker, Blasé, System Expert, Young Minded, Value Seeker, Status Quo, and Fit & Happy, wherein the attitudinal segment corresponds to a personal attitude characteristic of the individual as expressed in the set of data elements.
